(19) United States
(12) Patent Application Publication
(10) Pub. No.: US 2020/0260365 A1
(43) Pub. Date: Aug. 13, 2020

(54) System and method to share Wi-Fi network

(71) Applicant: Yongbiao Liu, Salinas, CA (US)

(72) Inventor: Yongbiao Liu, Salinas, CA (US)

(21) Appl. No.: 16/271,869

(22) Filed: Feb. 10, 2019

(51) Int. Cl. H04W 48/16; H04L 29/06

(52) U.S. Cl. CPC H04W 48/16; H04W 84/12; H04L 63/083

(57) ABSTRACT

The current invention provides a system and method for sharing Wi-Fi network primarily among neighborhood households to reduce cost of accessing internet. The invention comprises a server, an application software, multiple Wi-Fi networks registered for sharing, and multiple wireless devices with the application software. The invention comprises steps of registering user accounts including submission of payment method. Furthermore the said multiple registered Wi-Fi networks have their SSIDs, Wi-Fi login passwords, street addresses, and payment receiving methods registered with the server and stored in a database of the said server. The invention further comprises steps of using the application on wireless devices to select one or more cities to use registered Wi-Fi networks, and then download SSIDs, Wi-Fi login passwords, and addresses of registered Wi-Fi networks for the selected city or cities from the server, and then identify registered Wi-Fi network(s) by comparing SSIDs of discovered Wi-Fi networks at a place for using a registered Wi-Fi network in the selected city with downloaded registered Wi-Fi networks, and then login an identified registered Wi-Fi network by entering the downloaded network login password to connect a wireless device to the registered Wi-Fi network. The system and method to share Wi-Fi network further comprises steps of accepting payment by users of shared Wi-Fi networks to the server and sending payment from the server to a registered financial account by the Wi-Fi network owner.

### BACKGROUND OF THE INVENTION

### 1. Field of the Invention

The present invention relates to technique used for wireless Internet connection; and more particularly the present invention relates to system and method on sharing short range wireless network or Wi-Fi to enable Internet connection for wireless computing devices.

### 2. Description of the Related Art

There are prior arts related to sharing Wi-Fi network such as U.S. Pat. Nos. 7,382,771, 8,559,369, and 9,014,634. However, all of them are substantially different from the current invention.

### SUMMARY OF THE INVENTION

For internet connection at home, each household typically has its own Wi-Fi network for members of the household. Each Wi-Fi network typically can connect more wireless devices than the available wireless electronic devices in a household. In urban areas, many people live in apartment buildings or multi-family complexes with a high density of households. Although, a Wi-Fi network of one household can be received at good strength in surrounding households, most household Wi-Fi networks are password-protected and do not allow other people to access. However, if sharing Wi-Fi networks can bring some benefits such as monetary benefits, people may become encouraged to share their Wi-Fi networks with others to reduce their internet access costs. Some people may even choose to use their neighbor's Wi-Fi networks at substantial low costs than owning their own Wi-Fi networks for internet connection. This can reduce numbers of Wi-Fi networks needed and result in cost savings for Internet access.

The primary objective of the current invention is to provide a system and method to make it possible and practical to reduce costs of Internet access among neighbors by sharing Wi-Fi networks. To achieve this objective, the current invention comprises a server, an application software (App or application), multiple Wi-Fi networks registered for sharing, and multiple wireless computing devices with the application software for using shared Wi-Fi networks. The present invention also comprise steps for a user of a shared Wi-Fi network to register a user account by submitting an account name, a password, contact information, and a payment method such as credit card information using the application on the wireless device. The present invention also comprises steps to register a Wi-Fi network for sharing and the steps include login to an account on App and submission of SSID, password, and address of the Wi-Fi network. The owner also submits contact information and a method for receiving payment such as financial account information. The information of account registration and Wi-Fi network registration is transmitted to the server and stored in a database of the server.

To use a shared Wi-Fi network on a wireless device such as a notebook computer which does not have a mobile data plan from a mobile service carrier, the present invention comprises steps: (a) login the App and select one or more locations where shared Wi-Fi networks will be used on the App while the device is connected to Internet. The location can be a city or a zip code for the area covered by the zip code, (b) the App downloads identification data of registered Wi-Fi networks in the selected locations including SSIDs, passwords, and addresses from the server onto the wireless devices, (c) use the App to identify a registered Wi-Fi network at a place within the selected location(s) where the user wants to use a shared Wi-Fi network on a wireless device by comparing discovered Wi-Fi networks on the device with downloaded registered Wi-Fi network identification data, and (d) the App connects the device to an identified registered Wi-Fi network by entering the login password in network login of the registered Wi-Fi network.

To use a shared Wi-Fi network on a wireless device with a data plan such as a smartphone, the user can select the current location to download identifications of registered Wi-Fi networks for the current location and then proceed to identify and connect to a registered Wi-Fi as described in the steps (c) and (d) as described above. The present invention can have different embodiments but without fundamental deviation from the basic steps described above. For example, a user can set to allow the App to select a shared Wi-Fi automatically or allow the user to manually select a registered Wi-Fi network on the App when multiple registered Wi-Fi networks are identified at a same place to login. The App also repeats the download of identifications of registered Wi-Fi networks to update the registered Wi-Fi identification database of the App on the device for the selected locations periodically when the device is connected to internet.

When multiple registered Wi-Fi networks have a same SSID, the present invention may have different embodiments for matching a discovered Wi-Fi network with the same SSID on the device with a correct registered Wi-Fi network. One embodiment is to allow the App to use the passwords of the registered Wi-Fi networks with the same SSID to login the discovered Wi-Fi network in sequence until the login is successful. In another embodiment, addresses of the registered Wi-Fi networks with the same SSID are revealed to allow the user to select a correct registered Wi-Fi network to login.

As one of the primary objective of the present invention is to reduce cost of Internet access by sharing home Wi-Fi networks among neighborhood residents, the present invention also comprises steps to charge a fee to users of shared Wi-Fi networks and pay the owners of shared Wi-Fi networks by the operator of the Wi-Fi share program based on the present invention. There is a plurality of methods to determine charges to the users and payments to Wi-Fi network owners. One of method is to charge a monthly subscription fee for each user to cover two wireless devices for using any shared Wi-Fi network anywhere. One of methods to pay the owners of shared Wi-Fi networks is to pay based on length of time a shared Wi-Fi network is used with a maximum limit for each month.

Furthermore, other steps may be introduced to add more functions to the App in any suitable manner in one or more embodiments. One skilled in the relevant art will recognize that the invention can be practiced without one or more of the specific features or advantages of a particular embodiment.

### Definitions

Application refers to an application program or application software, and is a computer software package that performs a specific function directly for an end user or, in some cases, for another application. App is also used as an abbreviation for application in this invention.

Server is a computer program that provides a service to another computer programs (and its user). In a data center, the physical computer that a server program runs in is also frequently referred to as a server. That machine may be a dedicated server or it may be used for other purposes as well. In the client/server programming model, a server program awaits and fulfills requests from client programs, which may be running in the same or other computers. A given application in a computer may function as a client with requests for services from other programs and also as a server of requests from other programs.

Smartphone is a mobile phone that performs many of the functions of a computer, typically having a touchscreen interface, Internet access, and an operating system capable of running downloaded applications.

SSID stands for “Service Set Identifier” and is used for naming wireless networks. When multiple wireless networks overlap in a certain location, SSIDs make sure that data gets sent to the correct destination.

Wi-Fi (short for “wireless fidelity”) is a terminology that refers to short range wireless connection to a wireline broadband connection. The name is also written as WI-FI, WiFi, or wifi. Wi-Fi also refers to next generation Wi-Fi technology including Wi-Fi 5 and Wi-Fi 6.

### BRIEF DESCRIPTION OF THE DRAWINGS

FIG. 1 is a schematic view of components of a preferred embodiment of the present invention;

FIG. 2 is a flowchart showing steps of registering an account and a Wi-Fi network for sharing of the preferred embodiment of the present invention;

FIG. 3 is a flowchart showing steps of the method of using a registered Wi-Fi network on a wireless device of the preferred embodiment of the present invention;

### DETAILED DESCRIPTION

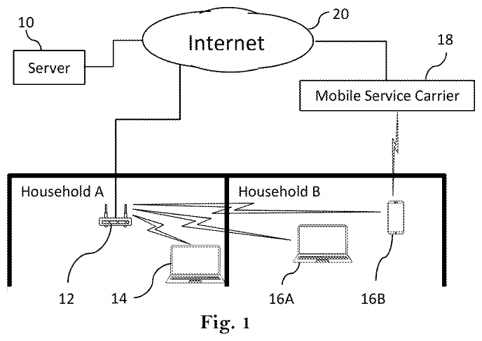

FIG. 1 is a schematic representation of components of a preferred embodiment of the current invention. The preferred embodiment comprises a server 10 connected to Internet 20, a registered Wi-Fi network for sharing 12 and an wireless device such as a notebook computer 14 with application software (App) downloaded and installed for sharing Wi-Fi network 12 in a household (household A), and one or more wireless devices 16A, 16B in a neighbor household (household B) with App installed for Wi-Fi network sharing. The owner of the Wi-Fi network 12 registers the network through App on the wireless device 14 and the registration data is stored in a database of the server 10. To use the Wi-Fi network 12, the owner of the wireless devices 16A, 16B uses App to register and login an account and then at a location where internet connection is available select one or more location such as city or mailing zip code to download identifications and login passwords of all registered Wi-Fi networks in the selected location(s) into a database of App on the wireless device 16A, 16B. In the household B, App on the wireless devices 16A, 16B identifies the Wi-Fi network 12 as a registered Wi-Fi network among discovered Wi-Fi networks on the devices and connects the wireless devices to the Wi-Fi network 12 by entering the password for the Wi-Fi network 12 from the database of App in network login. For the smartphone wireless device 16B which is connected to a mobile service carrier 18, the current location is selected on App to download registered Wi-Fi network identifications and passwords.

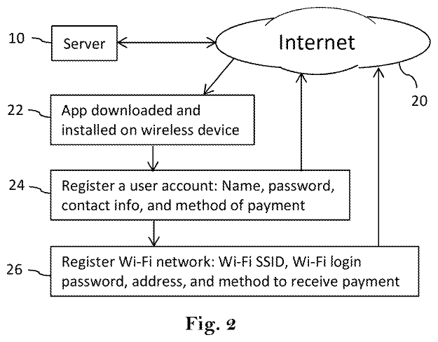

FIG. 2 is a flowchart showing steps of registering a user account and registering a Wi-Fi network. App is downloaded from internet and installed on a wireless device 22. The user then registers an account using App with name, password, and a method of payment 24. The register information is transmitted through internet to be stored in a database of the server 10. An owner of a Wi-Fi network can register his/her Wi-Fi network while logged in to his/her account by submitting SSID, login password, street address of the Wi-Fi network and a method to receive payment 26. The Wi-Fi registration information is transmitted through Internet to be stored in a database of the server 10.

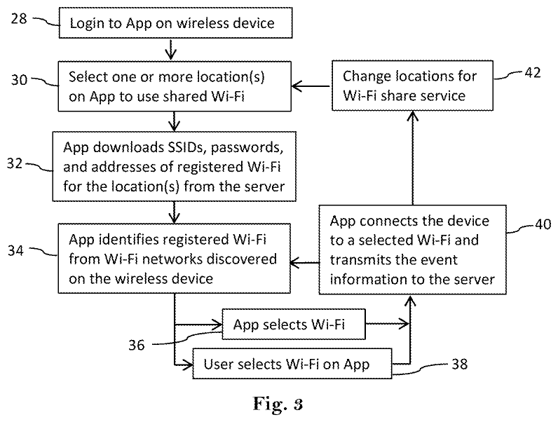

FIG. 3 shows steps for the preferred embodiment of the current invention to use a shared Wi-Fi network on a wireless device. At a location where the wireless device is connected to internet, the user logins the App on a wireless device 28 and then selects one or more locations such as cities or zip codes where shared Wi-Fi networks are to be used 30. The App will then download SSIDs, passwords, and addresses of registered Wi-Fi networks for the selected locations 32. At a place within the selected locations where shared Wi-Fi will be used, the user uses the App to identify registered Wi-Fi networks from discovered Wi-Fi connections on the wireless device 34. Then the user can set to have App select a registered Wi-Fi network to login automatically 36 or select a registered Wi-Fi network manually on the App 38 and the App then connects the wireless device to the selected Wi-Fi network by entering the required password in Wi-Fi login and transmits the event information including Wi-Fi network identity and time of login to the server 40. The user can also select a different Wi-Fi connection when the user moves to a different place within the selected location(s) or is not satisfied with the selected Wi-Fi network by letting App to repeat the process of identifying registered Wi-Fi networks from discovered Wi-Fi networks on the device again 34. To use Wi-Fi share at a different location outside the previously selected location(s) 42, the user repeat the process starting from selecting one or more locations again on the App 30.

The Figures illustrate the functionality and operation of possible implementations of the present invention in a particular embodiment and are not intended to be limiting of the invention. The description of the present invention is not intended to be exhaustive or limited to the invention in the form disclosed. Other modifications and variations will be apparent to those of ordinary skilled in the art without departing from the scope of the invention. The embodiment was chosen in order to best explain the principles of the invention and the practical application.

1. A system and method to share Wi-Fi network comprises a server, an application software, multiple Wi-Fi networks registered for sharing, and multiple wireless computing devices with the application software; and comprises steps of using the application to connect a wireless device to a registered Wi-Fi network; and the said steps comprise using the application software on a wireless device to select one or more location(s), download identifications and login passwords of registered Wi-Fi networks for the selected location(s), identify a registered Wi-Fi network from Wi-Fi networks discovered on the wireless device, and connect the wireless device to a registered Wi-Fi network by entering the required password in Wi-Fi login.

2. The system and method to share Wi-Fi network as in the claim 1 where location(s) is a city or an area covered by a mailing zip code.

3. The system and method to share Wi-Fi network as in the claim 1 where the registered Wi-Fi networks having their SSIDs, login passwords, street addresses submitted to the said server to be stored in a database of the said server; and the steps to register a Wi-Fi network further comprises submitting a financial account information for receiving payment.

4. The system and method to share Wi-Fi network as in the claim 1 where each user of shared Wi-Fi networks registers an account by submitting name, contact information, and a payment method using the application software on a wireless device.

5. The system and method to share Wi-Fi network as in the claim 1 where a user selects on the application one or more locations where a registered Wi-Fi network is to be used and the application will then download SSIDs, passwords, and addresses of all registered Wi-Fi networks for the selected locations onto the device; and further the application identifies one or more registered Wi-Fi networks from Wi-Fi connections discovered on the wireless device and connects the device to a registered Wi-Fi network.

6. The system and method to share Wi-Fi network as in the claim 1 where the wireless device is a smartphone with a data plan from a telecommunication service carrier and the application on the device selects the current location and downloads SSIDs, passwords, and addresses of all registered Wi-Fi networks at the current location; and further identifies one or more registered Wi-Fi networks from Wi-Fi connections discovered on the smartphone and connects the smartphone to a registered Wi-Fi network.

7. The system and method to share Wi-Fi network as in the claim 1 further comprises steps of accepting payment by users of shared Wi-Fi networks to the server and sending payment from the server to a registered financial account by the Wi-Fi network owner.

8. A system and method to share Wi-Fi network comprises a server, an application software, multiple Wi-Fi networks registered for sharing, and multiple wireless devices with the application software; and furthermore the said multiple registered Wi-Fi networks have their SSIDs, Wi-Fi login passwords, and street addresses registered with the server and stored in a database of the said server; and comprises steps of using the application on wireless devices to select one or more cities to use registered Wi-Fi networks, and then download SSIDs, Wi-Fi login passwords, and addresses of registered Wi-Fi networks for the selected city or cities from the server, and then identify registered Wi-Fi network(s) by comparing SSIDs of discovered Wi-Fi networks at a place for using a registered Wi-Fi network in the selected city with downloaded registered Wi-Fi networks, and then login an identified registered Wi-Fi network by entering the downloaded network login password to connect a wireless device to the registered Wi-Fi network.
